(19) United States
(12) Patent Application Publication
(10) Pub. No.: US 2017/0228006 A1
(43) Pub. Date: Aug. 10, 2017

(54) INSPECTION DEVICE AND METHOD FOR MULTIPLE POWERED DEVICES IN A POWER OVER ETHERNET SYSTEM

(71) Applicant: IC Plus Corp., Hsinchu City (TW)

(72) Inventor: Hann Yun TARN, Hsinchu City (TW)

(21) Appl. No.: 15/077,339

(22) Filed: Mar. 22, 2016

(30) Foreign Application Priority Data
Feb. 4, 2016 (TW) 105103700

(51) Int. Cl. G06F 1/28; G06F 1/26

(52) U.S. Cl. CPC G06F 1/28; G06F 1/266

(57) ABSTRACT

An inspection device installed in the power source equipment of a Power over Ethernet system for inspection of multiple powered devices connected to a plurality of connecting ports provided in the power source equipment. The inspection device applies an inspection signal to the connecting ports, samples a response signal at the connecting ports and determines whether a qualified powered device is connected to the connecting port, based on the response signal. The inspection device comprises a control means to prevent the inspection device from sampling the response signal at one connecting port, during the time when the inspection device is sampling a response signal at another connecting port. A method performing the inspection of the inspection device is also disclosed.

### CROSS REFERENCE TO RELATED APPLICATIONS

This non-provisional application claims priority under 35 U.S.C. §119(a) on Patent Application No(s). 105103700 filed in Taiwan, Republic of China on 2016 Feb. 4, the entire contents of which are hereby incorporated by reference.

### BACKGROUND OF THE INVENTION

Field of Invention

The present invention relates generally to a power over Ethernet system, and more particularly to an inspection device and method for multiple powered devices in a power over Ethernet system.

Related Art

Power over Ethernet (PoE) has found widespread application in many areas. For example, IEEE has released two standards that relate to PoE-IEEE 802.3af in 2003 and IEEE 802.3at in 2009. These standards are adopted by many applications. In this disclosure, these relevant standards relevant to the PoE will be referred to as the “PoE standard” hereinafter. PoE technology allows supplying electric power through Ethernet to devices such as Internet phone, wireless stations, network cameras, hubs, and even computers without the need of extra power outlet. Combining data transmission and power supply, PoE technology can reduce the cost and complexity of the overall network computing system.

In a power over Ethernet (PoE) system, the electric power is provided by the power source equipment (PSE) via Ethernet data cable to the powered device (PD). The power source equipment may include an Ethernet switch, a router, or other network switching and midspan devices. In the PoE system, a power device is connected to the network and configured to obtain or request power from the power source equipment over the network.

In a PoE system, the power source equipment may connect to multiple power devices through their network connecting ports, but may also connect to devices that will not or cannot obtain power from the power source equipment. In a real application, the powered device may include devices that are in compliance with the PoE Standard, and devices that are compatible with the PoE Standard. The PoE Standard provides that, before a power source equipment may provide power to a powered device, the power source equipment must determine whether the particular powered device is in accordance with the PoE standard. In addition, most of the power source equipment, or the power supply equipment that incorporates power source equipment, will also determine whether a device is compatible with the PoE standard. This may include a legacy device that is compatible with the PoE Standard. If compatible, the power source equipment will also provide power to such compatible device.

Under the PoE standard, when carrying out said inspection, the power source equipment provides a signal to the connecting port of a target device, and detects the response signal from the connecting port. If the response signal indicates a signature resistance ranging from 19k to 26.5k ohms, then the device is determined to be a powered device in compliance with the PoE standard. The PoE Standard also specifies that the voltage provided by the power source equipment should be between about 2.8 V and 10 V, the current should be less than about 5 mA, and the voltage difference of the testing signal should be more than 1 V.

During the inspection, a typical method is for the power source equipment to apply a voltage or current to the particular connecting port, and then to measure the response signal from the target device after a predetermined period. The signature resistance is calculated based on the current/voltage relationship from the two signals. If a current is applied, the current is normally in the range of 150 μA to 400 μA, and the voltage of the connecting port is measured to calculate the value of the signature resistance. In this case, a target device in compliance with the PoE standard will cause the power sourcing device to detect an about 2.8 V to 10 V voltage drop in the connecting port.

Alternatively, if the testing signal is a voltage signal, the voltage is generally between about 2.8V to 10V, and the detected current value shall be between about 87.5 uA to 625 uA.

Based on the result, the power source equipment will decide whether to perform classification on the powered device. From the classification, the power source equipment may provide different power to different power devices.

However, in application the power source equipment of the PoE system would provide a plurality of network ports to be connected by qualified powered devices and non-qualified devices. In addition, not all ports would be necessarily connected by a powered device or other devices. It is not possible for the power source equipment to predict when a new powered device will be connected to any of the ports. As a result, the power source equipment needs to inspect the plurality of ports from time to time, in order to determine whether a PoE Standard complying power device or a compatible powered device is connected to the respective ports and, when yes, to determine a voltage or current upper limitation for supplying power to the ports.

U.S. Pat. No. 7,856,561 provides an equipment to detect a legacy device in a PoE system. The power source equipment therein will apply a serial signal, including current I1 and I2, to the target connecting port. Respectively after 160 ms, it will detect the voltage of the connecting port as V1 and V2. Based on the ratio between the voltage difference and current difference, it will determine whether the target device associated with the connecting port is a standard-compliant powered device, or a compatible device. Specifically, it will calculate the value of Rdet=(V1−V2)/(I1−I2). If Rdet is within a certain range, it will determine that the target device is a standard-compliant powered device. If the value of Rdet is less than the predetermined value or is a negative value, then it will determine that the target device is a legacy device. If none of the above conditions has been met, then it will determine that the device is neither a standard-compliant powered device nor a legacy device.

Chinese Patent No. CN101031861 discloses a classification method for the powered devices in a wired data telecommunication network. It applies multiple periodic testing signals to a powered device to generate a multi-group classification result. The classification result is mapped to an index table to produce a code used as the classification code.

In addition to the voltage range requirement, the PoE standard also requires that the capacitance of the powered device shall be 0.15 uF. If the capacitance is above 10 uF, it must refuse to supply power. Under this requirement, the power source equipment must also determine the capacitance of the target device to determine whether it is a powered device that it can supply power to.

U.S. Pat. No. 8,412,961 discloses a circuit and method for detecting a legacy device in a power over Ethernet system. The method can determine whether the target device connecting to the particular connecting port is a powered device in compliance with the PoE standard or a legacy device. The method uses a three-level voltage or current as the testing signal, and based its determination on the detected current or voltage measured in the connecting port. The patent also discloses that the three levels can in fact be two levels, whereas the first level and the third level are the same, i.e., the third level applies the same measurement as the first level does.

Prior PoE system is limited by its ability to predict types and number of the powered devices that may be connected to the connecting ports. A lot of them can be unknown to the PoE system. Most power source equipment is configured to inspect one single powered device or connecting port connected by a device to be inspected. When a plurality of powered devices is to be inspected, the inspection device of the for the power source equipment needs to inspect, and classify, the connecting ports one by one in a sequence, such as according to the time sequence of their connection. In such a mechanism the inspection/classification time is made longer, always long enough to jeopardize the powering of the powered devices.

Nevertheless, in actual applications results of the inspection may not necessarily be effective or correct; the inspection of one connecting port may not be completed within one inspection attempt.

In order to inspect and/or classify a plurality of powered devices, one conventional approach provides a plurality of inspection devices. Basically equal number of inspection devices and connecting ports is provided, so that each inspection device inspects and classifies its corresponding connecting port/powered device. Inspection time is shortened. However, the increased number of inspection devices at the same time increases the manufacture cost and the volume of the power source equipment.

There is yet to exist a power source equipment of the power over Ethernet that is able to inspect a plurality of connecting ports in substantial one step, in order to identify and classify powered devices, without the need of a plurality of inspection devices.

It is an objective of the present invention to provide a novel inspection device for the PoE system, with the capability of inspecting a plurality of powered device in substantially one step.

It is an objective of the present invention to provide a novel inspection device for the PoE system, with the reduced overall inspecting time on a plurality of powered device.

It is an objective of the present invention to provide an inspection device for the PoE system, wherein a single inspection device is used to inspect a plurality of powered devices.

It is an objective of the present invention to provide an inspection method that has the above advantages.

In one aspect, the present invention features an inspection device for the powered device in the PoE system. The inspection device is incorporated into a power source equipment of the PoE system. The power source equipment provides at least two connecting ports, which allow a powered device to connect thereto via a network wire. The inspection device may apply to the plurality of connecting port an inspection signal and, after the inspection signal is applied, sample at the corresponding connecting ports to obtain a response signal. The inspection device may further determine based on the obtained response signal whether a device to be inspected is connected to the connecting port and, if yes, whether the device to be inspected is a qualified powered device.

The inspection device further comprises a control means, configured to prevent the inspection device to sample the response signal from a connecting port during the time when the inspection device samples a response signal from another connecting port.

In the preferred embodiments of this invention, the inspection device is further configured to apply a classification inspection signal to a connecting port connected by a device having been determined as a qualified powered device and, after the classification inspection signal is applied, sample at the connecting port to obtain a classification response signal. The inspection device further determines a power value to be supplied to the connecting port, based on the classification response signal so obtained.

In such embodiments, the control means of the inspection device for PoE system is further configured to prevent the inspection device to sample the classification response signal from a connecting port during the time when the inspection device samples a response signal or a classification response signal from another connecting port.

In another aspect, the present invention relates to a method for inspecting a plurality of powered devices performed by a power source equipment of the PoE system that comprises an inspection device comprising a control means to control an operation of the inspection device and provides at least two connecting ports, each allowing a powered device to connect thereto via a network wire. The inspection device may apply to the plurality of connecting ports an inspection signal and sample at the connecting ports to obtain a response signals. The inspection device may further determine based on the obtained response signal whether a device to be inspected is connected to the connecting port and, if yes, whether the device to be inspected is a qualified powered device. The method comprises the following steps:

the inspection device applying an inspection signal to a plurality of connecting ports, sampling a response signal from the connecting ports after applying the inspection signal and determining whether a device is connected to the connecting port and, if yes, whether the device is a qualified powered device, based on the response signal so obtained;

the inspecting device applying a classification inspection signal to a connecting port determined as being connected by a qualified powered device, sampling a classification response signal from the connecting port after applying the classification inspection signal and determining a power value to be supplied to the connecting port, based on the classification signal so obtained;

the control means preventing the inspection device from sampling the response signal or the classification response signal at a connecting port, during a time when the inspection device samples a response signal or a classification signal at another connecting port; and

the power source equipment supplying the plurality of connecting port a power determined based on the classification response signal.

According to this invention, the inspecting device continues to apply inspection signals or classification inspection signals to the plurality of connecting ports and samples at the connecting ports response signals and classification response signals under the regulation of the control means. The overall inspection/classification time is thus tremendously reduced, as the one single inspecting device used in the power source equipment inspects the plurality of connecting ports/powered devices in a pipeline manner. The control means controls the sampling of the response signals and the classification response signals, confusions among inspections on different connecting ports may thus be avoided.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below and the claims. The drawings are not necessarily to scale. Emphasis is instead generally placed upon illustrating the general principles of the present invention. In these drawings, like numerals are used to indicate like parts throughout the various views.

FIG. 1 illustrates an embodiment of the inspection device for multiple powered devices in a PoE system according to an embodiment of this invention.

FIG. 2 illustrates the inspection method for multiple powered devices in a PoE system according to an embodiment of the present invention.

FIG. 3 is timing chart of the method of FIG. 2.

### DETAILED DESCRIPTION OF THE INVENTION

The present invention will be apparent from the following detailed description, which proceeds with reference to the accompanying drawings, wherein the same references relate to the same elements.

The present invention provides a novel inspection device and method for multiple powered device in a PoE system. The present invention allows the power source equipment of a PoE system to determine, in a pipeline manner, whether the devices connected thereto is suitable for supplying power to and, if yes, the power to be supplied to the device. Time needed in the inspection and classification of the powered devices is tremendously reduced. Only one inspection device is needed in the inspection and classification of a plurality of powered devices.

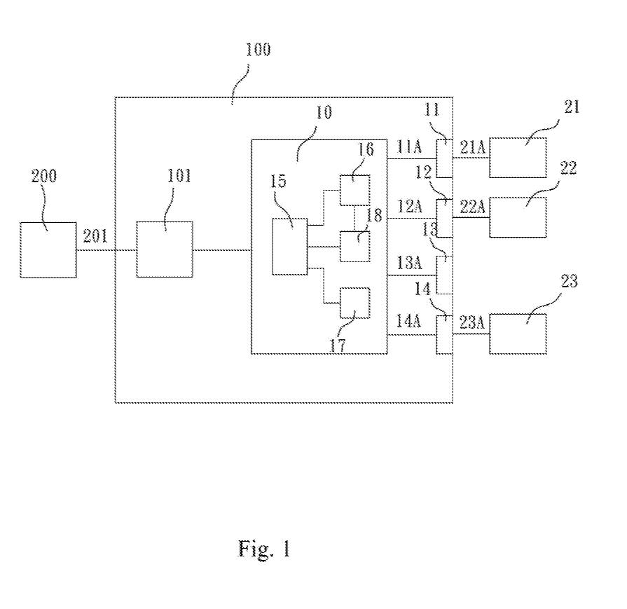

FIG. 1 illustrates an embodiment of the inspection device for multiple powered devices in a PoE system of this invention. As illustrated, the inspection device 10, used for inspecting a plurality of powered devices in the PoE system, is incorporated into a power source equipment 100 of the PoE system. Together with the power source equipment 100 and the power source 200, they constitute the PoE system. The power source equipment 100 provides power, from the power source 200 and through the power cable 201 to the powered devices. The power source 200 provides power through the power cable 201 into the I/O Interface 101 of the power source equipment 200, and finally into the inspection device 10. The power source equipment 100 also provides multiple connecting ports 11, 12, 13 and 14. They allow connection to the external devices 21, 22, 23 through the network wire 21A, 22A, and 23A. Although FIG. 1 illustrates only four connecting ports, a person of ordinary skill in the art will recognize that the number of ports can be greater or less than the number illustrated. For example, a typical power source equipment 100 can offer 8 connecting ports. The present invention is applicable to these cases as well. As illustrated, there are three external devices 21, 22, and 23 connecting to the connecting ports 11, 12 and 14. There is no external device connecting to the connecting port 13. The external devices 21, 22 and 23 may be powered devices in compliance with the PoE standard, may be compatible powered devices, may be incompatible powered devices, or may be just a typical capacitor load or resistor load.

The power source equipment 100, via 4 sets of signal wires 11A, 12A, 13A, and 14A, connects to the connecting ports 11, 12, 13, and 14. The function of the power source equipment 100 is to transfer the power from the power source 200 to the external devices 21, 22 and 23 that are capable of receiving power.

In general, the signal wires 11A, 12A, 13A and 14A may each comprise 2 pairs of signal lines for transmitting electric signal and power. At the same time, the network wires 21A, 22A, and 23A may each comprise 2 pairs of signal lines in the shape of a twisted pair. A person of ordinary skill in the art would recognize that the number of lines inside the signal wire or the network wire may vary, as long as each of them has a pair of signal wires.

The PoE system configured as above is well known in the art, and various techniques have been reported in the literature, including the IEEE 802.3af, and IEEE 802.3at standards.

According to the PoE standard, a standard-compliant power source equipment must first conduct inspection and classification toward the external devices 21, 22 and 23 before providing power to a suitable external device. For those devices that are in compliance with, or compatible with, the PoE standard, there currently exists methods and devices to inspect and classify these devices, such as the disclosure in the U.S. Pat. No. 7,856,561 and U.S. Pat. No. 8,412,961.

In an ideal situation, all external devices connected the connecting ports 11, 12 and 14 are powered devices in compliance with or compatible with the PoE standard. During the inspection stage, these external devices can be called “target devices.” When it is determined that a target device is in compliance with the PoE standard, the device is then called a powered device or a qualified powered device. In the following description, external devices 11, 12, 14 connected to the connecting ports and under inspection will be referred to as “targeted devices” and those determined to be suited for supplying power, i.e., in compliance with the PoE standards or compatible with the PoE standards, will be referred to as “powered devices.”

FIG. 1 further shows the power source equipment 100 of this embodiment includes an inspecting device 10, to inspect whether targeted devices 21, 22, 23 connected with the respective connecting ports 11, 12, 13, 14 are suited for supplying power to and, if the results is positive, the power level to be supplied to the qualified powered devices 21, 22, 23. Such inspecting device 10 may be any known inspecting device generally used in the power source equipment of a PoE system and mainly comprises in its circuitry an inspection signal generator 16, a response signal sampler 17 and an operation unit 15. In the known art, the inspection signal generator 16 generally apply a voltage signal to a particular connecting port and, thereafter, the response signal sampler 17 samples a response signal in response to the inspection signal at the connecting port, converts the response signal to a current signal and provides the response signal to the operation unit 15. The operation unit 15 then determines whether the device connected to the connecting port is a powered device suited for supplying power and, if yes, the power level to be supplied to the powered device. Alternatively, the inspection signal generator 16 may also apply a current signal to the particular connecting port and the response signal sampler 17 samples the response signal and converts the response signal into a voltage signal. In such a case, the operation unit 15 determines and classifies in accordance to the nature of the response voltage signal.

An inspecting device 10 with the scheme and functions described above is known to those having ordinary skills in the art. The technologies used in the inspecting device 10 have been disclosed and discussed in a variety of standards and patent documents. Details thereof are thus omitted. In the following description, inspections that determine whether a connecting port is connected by a targeted device and whether the targeted device is a qualified powered device will be collectively referred to as “inspection” or “inspection of a powered device,” while inspection that determines a power level to be supplied to a powered device will be referred to as “classification” or “classification of a powered device.”

The functions of the inspecting device for multiple powered device in a PoE system are to inspect a plurality of connecting ports 11, 12, 13, 14, in order to determine whether the respective connecting ports 11, 12, 13, 14 are connected by a targeted device, whether the respective targeted devices 21, 22, 23 connected to a particular connecting port are a qualified powered device and a power level to be supplied to the respective powered devices. In this respect, the inspection signal generator 16 is configured to apply an inspection signal to a plurality of connecting ports and to apply a classification inspection signal to a connecting port determined by the operation unit 15 to be in connection with a qualified powered device. In the embodiments of this invention, the inspection signal generator 16 generally applies an inspection signal to a connecting port, when a device connected to the connecting port but yet supplied electrical power is detected.

The present invention provides a new scheme of the inspecting device used in the power source equipment of the PoE system. As shown in FIG. 1, in addition to the operation unit 15, the inspection signal generator 16 and the response signal sampler 17, the inspecting device 10 further comprises a control means 18. The main function of the control means 18 is to control the sampling operation of the response signal sampler 16 in the response signals and the classification response signals. That is, timing of sampling of a response signal that is used to determine whether a connecting port is connected by a targeted device and whether the connecting device is a qualified powered device and timing of sampling of a classification response signal that is used to determine a power level to be supplied to a qualified powered device. In the preferred embodiments, the control means 18 is configured to prevent the inspecting device from sampling a response signal/classification signal at one connecting port, in a time when the inspecting device samples a response signal/classification response signal at another connecting port.

Because in the power source equipment 100 only one detecting device 10 is provided, a collision would take place, when the response signal sampler 17 samples a response signal/classification response signal, at the same time period when it also samples one or a plurality of response signal/classification response signal.

However, since the control means of this invention separates the sampling operation of one response signal/classification response signal from the sampling operation of other response signal/classification response signals, the collision is effectively prevented.

According to this invention, whenever inspection and/or classification in the connecting ports 11, 12, 13, 14 is necessary, such as when a plurality of targeted devices 21, 22, 23 is connected to the connecting ports 11, 12, 13, 14 or likewise, the inspection signal generator 16 can always apply a series of inspection signal or classification inspection signal to the plurality of connecting port, while the response signal sampler 17 can correctly obtain the respective response signals or classification response signals in response to the corresponding inspection signals or classification inspection signals, without any collision. With this, the operation unit 15 can also inspect and classify the respective connecting ports 11, 12, 13, 14 in a pipeline manner.

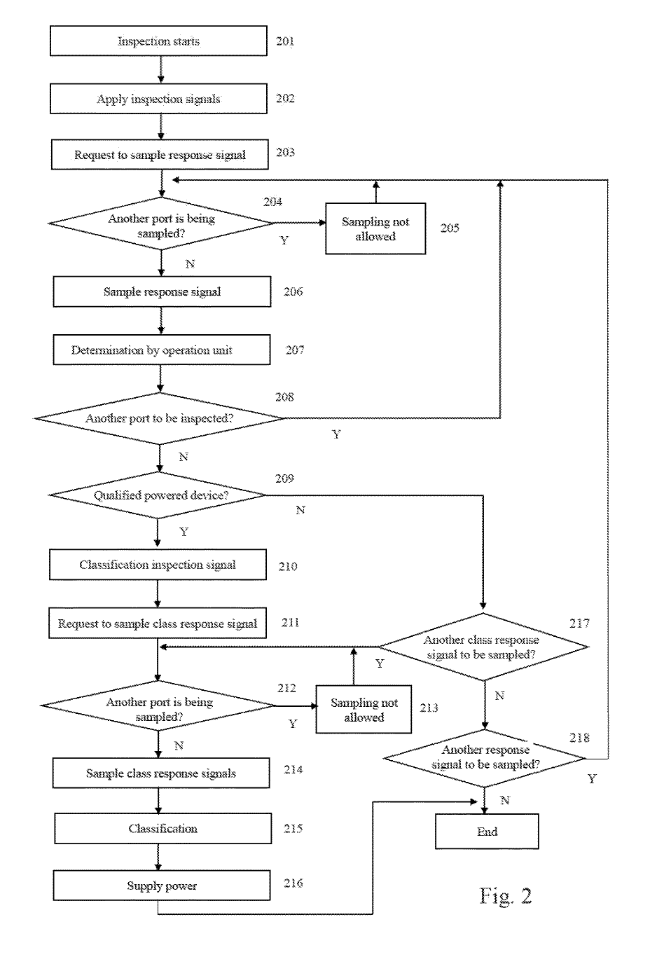

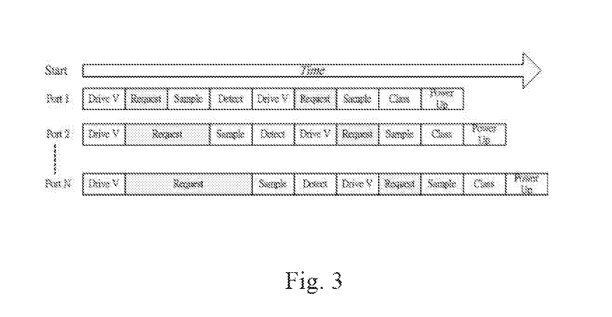

In the followings, method for inspecting a plurality of powered devices in a PoE system according to one embodiment of this invention will be described. FIG. 2 shows the flowchart of the embodiment method. The method shown in FIG. 2 may be performed in the inspecting device for multiple powered devices in a PoE system as shown in FIG. 1. In addition, FIG. 3 is timing chart of the method of FIG. 2.

As shown in FIG. 2, in the inspection/classification of multiple powered devices, at first at step 201 the operation unit 15 determines inspection/classification in all connecting ports 11, 12, 13, 14 or a portion thereof shall be conducted. In general, the operation unit 15 commences an inspection/classification operation, when software/hardware initialization of the system is completed. To determine whether inspection is necessary, the operation unit 15 detects the connecting ports in a predetermined sequence, to determine if any device is connected to the connecting ports, without being supplied power. When one or more targeted device is detected, the inspection and classification method of this invention will be performed. Of course, the inspection and classification method may also be initialized upon another event. Such conditions may be configured in the inspecting device 10 using any known technology.

In the inspection and classification of a plurality of connecting ports, the inspection signal generator 16 first applies an inspection signal to all the connecting ports 11, 12, 13, 14 at step 202. In general cases, the inspection signal is a voltage signal and may include a plurality of voltage signals. FIG. 3 shows such a voltage signal, while those having ordinary skills in the art may recognize that the inspection signal may be a current signal or any signal in another form or type. At 203 the response signal sampler 17 requests to connect first connecting port, in order to sample a response signal at the first connecting port. At 204 the control means 18 determines whether any connecting port is being sampled. If result of the determination is yes, the control means 18 declines the response signal sampler 17 for the requested connection at step 205; otherwise the response signal sampler 17 is connected to the first connecting port at step 206, allowing the response signal sampler 17 to sample response signal thereof. In the case shown in FIG. 3, since at this time point the response signal sampler 17 does not sample response signals at any connecting port, the control means 18 does not prevent the response signal sampler 17 at the first connecting port. At 207 a response signal is obtained from the first connecting port and is supplied to the operation unit 15, which in turn determines, using the obtained response signal, whether a targeted device is connected to the first connecting port and, if yes, whether the targeted device is suited for supplying power. If the inspection signal is a voltage signal, the response signal sampler 17 will convert the response signal into a current signal, for the operation unit 15 to make decisions. Of course, it is also possible to convert the obtained response signal into another form, for the operation unit 15 to make decisions.

At step 208 the response signal sampler 17 determines whether another connecting port needs to be sampled a response signal. If result of the determination is positive, the step returns to step 203, wherein the response signal sampler 17 requests to connect a second connecting port in order to sample a response signal. Otherwise, the inspection signal generator 16 determines at 209 whether any connecting port previously sampled at, such as the first connecting port, has been determined by the operation unit 15 as a qualified powered device. If result of this determination is positive, at step 210 the inspection signal generator 16 applies a classification inspection signal to all connecting ports, to which a powered device is determined to have connected. At step 211 the response signal sampler 17 requests to connect the first connecting port that has been applied a classification inspection signal, in order to sample a classification response signal. At step 212 the control means 18 determines whether any connecting port is being sampled a response signal or a classification response signal. If the determination is positive, at 213 the control means 17 stops the response signal sampler 17 from sampling a classification response signal at the first connecting port; otherwise, the response signal sampler 17 is connected to the first connecting port at step 214, in order to sample a classification response single therefrom. In the case shown in FIG. 3, at this moment no connecting ports are being sampled a response signal or a classification signal by the response signal sampler 17. Therefore, the control means 19 does not prevent the response signal sampler 17 from sampling a classification signal at the first connecting port. At step 215 a classification response signal is obtained and is provided to the operation unit 15, which determines a class of power level for supplying to the first connecting port. At 216, the power source equipment 100 supplies power to the first connecting port at a level determined in step 215. If result of determination in step 209 is negative, at step 217 the response signal sampler 17 determines whether another connecting port needs to be sampled a classification response signal. If not, it further determines whether another connecting port needs to be sampled a response signal at 218. If yes, the step returns to step 203; otherwise, the process ends at 219; otherwise, the step returns to 211.

In the embodiment described above, the inspecting device can apply an inspection signal or a classification inspection signal to all connecting ports that need inspection or classification, while sampling of the corresponding response signals or classification response signals is regulated by the control means 18. No collision or confusion among the response signals and the classification response signals will take place and a pipeline inspection and classification in the multiple powered devices may be realized. As shown in FIG. 3, the overall inspection/classification time for the plurality of connecting ports using only one inspecting device may be effectively shortened.

Although the invention has been described with reference to specific embodiments regarding the inspection device and method for multiple powered devices in a PoE system, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An inspection device incorporated in a power source equipment of a Power over Ethernet (PoE) system, wherein the power source equipment provides a plurality of connecting port, which allow a powered device to connect thereto via a network wire; wherein the inspection device applies to the plurality of connecting port an inspection signal, samples at the corresponding connecting ports to obtain a response signal and determines based on the obtained response signal whether a device to be inspected is connected to the connecting port and, if yes, whether the device to be inspected is a qualified powered device;
characterized in that the inspecting device further comprises a control means, configured to prevent the inspection device from sampling the response signal at a connecting port during the time when the inspection device samples a response signal at another connecting port.

2. The inspecting device according to claim 1, further configured to apply a classification inspection signal to a connecting port connected by a device having been determined as a qualified powered device, sample at the connecting port to obtain a classification response signal and determine a power value to be supplied to the connecting port, based on the obtained classification response signal;
characterized in that the control means is further configured to prevent the inspection device from sampling a response signal or a classification response signal at a connecting port during the time when the inspection device samples a response signal or a classification response signal at another connecting port.

3. A method for inspecting a plurality of powered devices performed by a power source equipment of a PoE system, wherein the power source equipment comprises an inspection device comprising a control means to control an operation of the inspection device and provides a plurality of connecting port, each allowing a powered device to connect thereto via a network wire; and wherein the inspection device connects the plurality of connecting port and is configured to apply an inspection signal to the connecting ports and obtain a response signal at the connecting ports; the method comprising the following steps:
the inspection device applying an inspection signal to a plurality of connecting ports, sampling a response signal from the connecting ports after applying the inspection signal and determining whether a device is connected to the connecting port and, if yes, whether the device is a qualified powered device, based on the response signal so obtained;
the inspecting device applying a classification inspection signal to a connecting port determined as being connected by a qualified powered device, sampling a classification response signal from the connecting port after applying the classification inspection signal and determining a power value to be supplied to the connecting port, based on the classification signal so obtained; and
the control means preventing the inspection device from sampling the response signal or the classification response signal at a connecting port, during a time when the inspection device samples a response signal or a classification signal at another connecting port.

4. The method according to claim 3, further comprising a step of supplying to the plurality of connecting port a power level determined based on the classification response signal.
